(19) United States
(12) Patent Application Publication
(10) Pub. No.: US 2008/0098152 A1
(43) Pub. Date: Apr. 24, 2008

(54) METHOD AND APPARATUS FOR CONFIGURING A MEMORY DEVICE

(76) Inventor: Josef Schnell, Charlotte, VT (US)

Correspondence Address: PATTERSON & SHERIDAN, LLP;Gero McClellan / Qimonda, 3040 POST OAK BLVD.,, SUITE 1500, HOUSTON, TX, 77056, US

(21) Appl. No.: 11/551,147

(22) Filed: Oct. 19, 2006

(51) Int. Cl. G06F 12/00

(52) U.S. Cl. 711/1

(57) ABSTRACT

Embodiments of the invention generally provide a memory device and a method for providing the memory device. In one embodiment, the method includes providing one or more layers including a memory array of the memory device. The one or more layers are arranged in a manner allowing selection of a configuration for the memory device from at least a first configuration and a second configuration. Operation of the memory device is different in the first configuration with respect to the second configuration. The method also includes selecting a configuration for the memory device from at least the first configuration and the second configuration. The method further includes providing a first layer disposed on the one or more layers if the first configuration is selected. The first layer corresponds to the first configuration. The method also includes providing a second layer disposed on the one or more layers if the second configuration is selected. The second layer corresponds to the second configuration.

### BACKGROUND OF THE INVENTION

1. Field of the Invention

The invention generally relates to methods and apparatuses for providing configurations of a memory device.

2. Description of the Related Art

Modern memory devices are typically included in a wide range of products including large computer systems and smaller embedded computer systems. In many cases, different types of computer systems may be configured to access different types of memory devices. For example, large computer systems with a dedicated power supply may be configured to operate with high-speed memory devices which consume large amounts of power while smaller embedded systems which operate on battery power may be configured to operate with low-speed memory devices which consume smaller amounts of power. Thus, a given type of memory device may be selected for use in a computer system based on power supply constraints. Data access rates, memory capacity, interface restraints, and other design factors may also be considered when selecting a memory device.

In some cases, a given memory device manufacturer may wish to provide a variety of memory devices to one or more customers developing computer systems with the varying memory requirements described above. In such cases, providing the variety of memory devices with varying operating characteristics may be expensive for the memory device manufacturer. For example, large design costs, testing costs, and manufacturing costs may be incurred for each different configuration of memory device being requested for each type of computer system. Such costs may result in a memory device which is more expensive, thereby causing the computer system containing the memory device to be more expensive.

Accordingly, what is needed are improved methods and apparatuses for providing configurations of a memory device.

### SUMMARY OF THE INVENTION

Embodiments of the invention generally provide a memory device and a method for providing the memory device. In one embodiment, the method includes providing one or more layers including a memory array of the memory device. The one or more layers are arranged in a manner allowing selection of a configuration for the memory device from at least a first configuration and a second configuration. Operation of the memory device is different in the first configuration with respect to the second configuration. The method also includes selecting a configuration for the memory device from at least the first configuration and the second configuration. The method further includes providing a first layer disposed on the one or more layers if the first configuration is selected. The first layer corresponds to the first configuration. The method also includes providing a second layer disposed on the one or more layers if the second configuration is selected. The second layer corresponds to the second configuration.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting a memory device 100 according to one embodiment of the invention.

FIG. 2 is a block diagram depicting masks used to fabricate different configurations of a memory device according to one embodiment of the invention.

FIG. 3 is a block diagram depicting a method 300 for manufacturing a memory device with a selected configuration according to one embodiment of the invention.

FIGS. 4A-B are block diagrams depicting separate configurations of the memory device according to one embodiment of the invention.

### DETAILED DESCRIPTION OF THE PREFERRED EMBODIMENT

Embodiments of the invention generally provide a memory device and a method for providing the memory device. In one embodiment, the method includes providing a substrate for the memory device and providing one or more layers including a memory array of the memory, device. The one or more layers are arranged in a manner allowing selection of a configuration for the memory device from at least a first configuration and a second configuration. Operation of the memory device is different in the first configuration with respect to the second configuration. The method also includes selecting a configuration for the memory device from at least the first configuration and the second configuration. The method further includes providing a first layer disposed on the one or more layers if the first configuration is selected. The first layer corresponds to the first configuration. The method also includes providing a second layer disposed on the one or more layers if the second configuration is selected. The second layer corresponds to the second configuration. In some cases, only a single layer and the connections to the layer may be different from the first configuration to the second configuration.

By providing the one or more layers which are arranged to allow selection of a configuration for the memory device, different configurations of the memory device may be manufactured using the base design of the one or more layers. Thus, design modifications between the first configuration and the second configuration may be reduced, thereby reducing design, testing, and manufacturing costs. In one embodiment, differences between the first configuration and the second configuration may be reduced to a single layer. Thus, during manufacturing, where different masks are used to fabricate each layer respectively, a single mask may be used to change between manufacturing of the first configuration and the second configuration. Other embodiments and advantages are also described in greater detail below.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Also, signal names used below are exemplary names, indicative of signals used to perform various functions in a given memory device. In some cases, the relative signals may vary from device to device. Furthermore, the circuits and devices described below and depicted in the figures are merely exemplary of embodiments of the invention. As recognized by those of ordinary skill in the art, embodiments of the invention may be utilized with any memory device.

### An Exemplary Memory Device

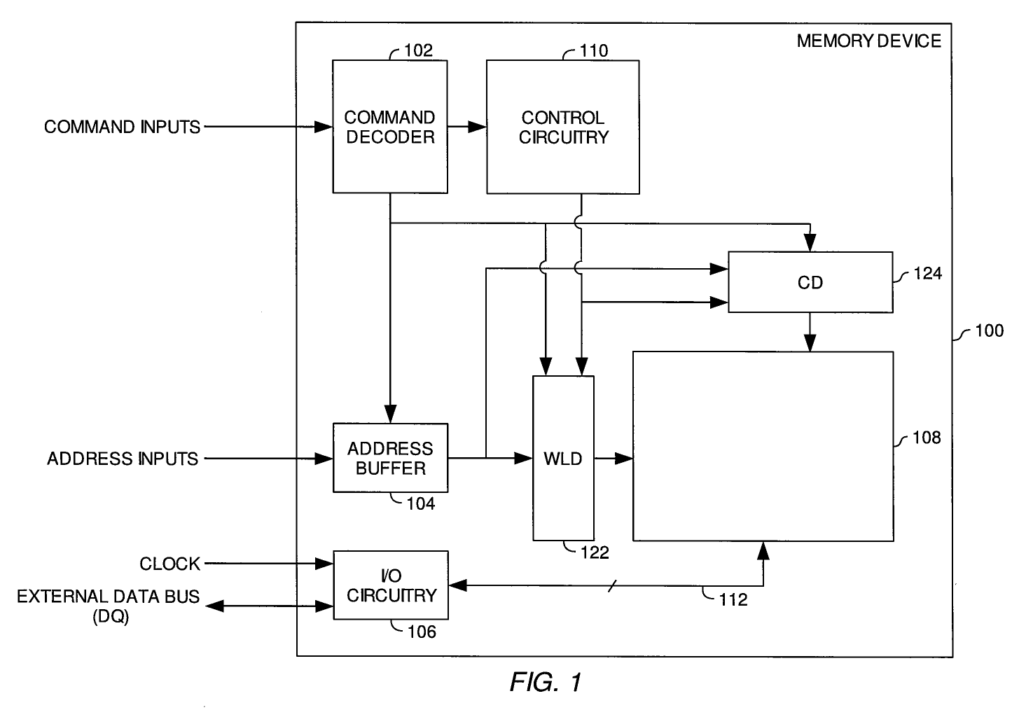

FIG. 1 is a block diagram depicting a memory device 100 according to one embodiment of the invention. The memory device 100 may include address inputs, command inputs, a clock input, and an external data bus (DQ). The address inputs may be received by an address buffer 104 and the command inputs may be received by a command decoder 102. The clock input and external data bus may be received by input/output (I/O) circuitry 106 and used to input and output data corresponding to access commands and addresses received via the command and address inputs. In some cases, the clock input may also be used to control the address buffer 104 and/or command decoder 102.

During an access, the address inputs may be used by a wordline decoder 122 and column decoder 124 to access memory cells in a memory array 108 which may include multiple memory banks. For example, using a received address, the column decoder 124 may select bitlines of the memory array 108 to be accessed. Similarly, the wordline decoder 126 may select wordlines to be accessed using the received address. In some cases, an access may also occur based on an address which is internally generated.

During an access, after an address has been used to select wordlines and bitlines in the memory array 108, data may be written to and/or read from the memory array 108 may be transmitted between read/write circuitry for the memory array 108 and the external I/O circuitry 106 via one or more internal data buses 112. The combination of features and elements described above with respect to FIG. 1 is merely one example of a memory device configuration with which embodiments of the invention may be used. In general, the embodiment of the memory device 100 depicted with respect to FIG. 1 is exemplary and embodiments of the invention may be utilized with any type of memory device.

### Providing Configurations for the Memory Device

As mentioned above, embodiments of the invention provide a memory device and a method for providing or manufacturing the memory device with a given configuration selected from one of multiple configurations. In one embodiment, selection of the given configuration may be provided via one or more layers which are arranged in a manner allowing selection of one of the multiple configurations. After a configuration has been selected, subsequent layers may be added to implement the selected configuration. Each configuration may correspond to a different operating characteristic of the memory device. For example, where a first configuration is selected during manufacturing, the resulting memory device may be a single data rate (SDR) dynamic random access memory (DRAM) device where data is transmitted to and from the memory device on a single clock edge (e.g., on the rising edge). Where a second configuration is selected, the resulting memory device may be a double data rate (DDR) DRAM device where data is transmitted to and from the memory device on both clock edges (e.g., on the rising and falling edges).

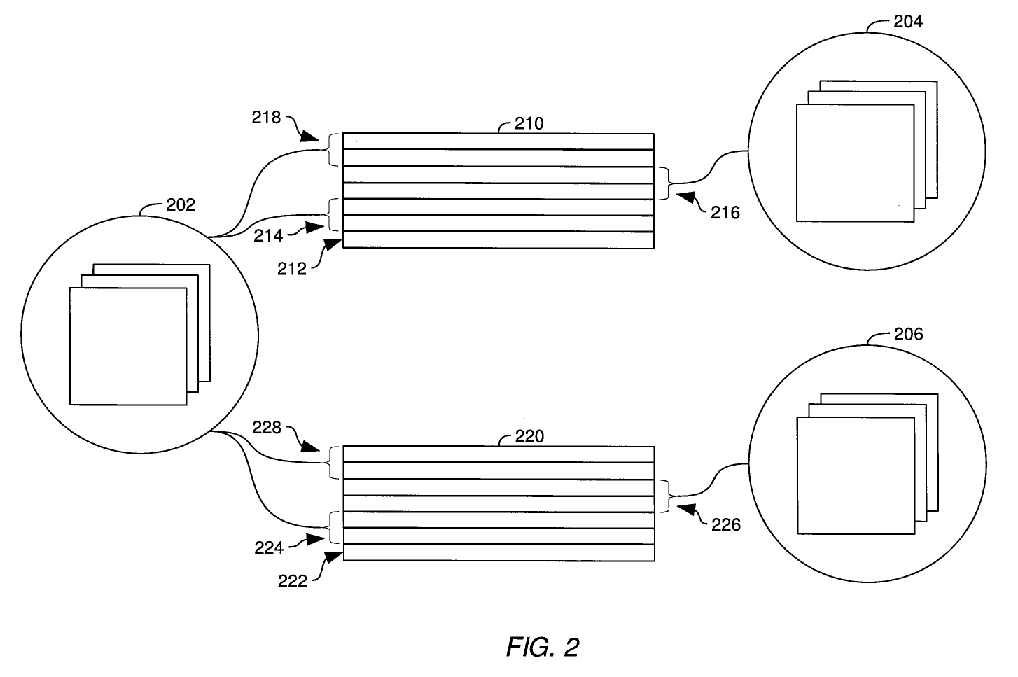

FIG. 2 is a block diagram depicting masks 202, 204, 206 used to fabricate different configurations of a memory device 210, 220 according to one embodiment of the invention. As depicted, each configuration of the memory device 210, 220 may begin with a substrate 212, 222 upon which layers 214, 266, 218, 224, 226, 228 may be deposited using masks 202, 204, 206. A set of common masks 202 may be used for layers 214, 218, 224, 228 in both configurations of the memory device 210, 220.

In one embodiment, separate masks 204, 206 may be provided for each different configuration 210, 220. For example, masks 204 may be used to deposit layers 216 for a first configuration of the memory device 210. Similarly, masks 206 may be used to deposit layers 226 for a second configuration of the memory device 220. In one embodiment, changing a single mask corresponding to a single layer may be used to select between the first and second configuration of the memory device 210, 220. In some cases, interconnections to the single layer (e.g., vias) in addition to the single layer may also be used to select between the first configuration and the second configuration of the memory device 210, 220. In one embodiment, the single layer may be a layer of metal, such as the metal one (M1) layer. In some cases, metal layers below the M1 layer, such as metal zero (M0) as well as any layers above the M1 layer, such as the metal two (M2) layer may be the same for each configuration.

As depicted, layers 214, 218, 224, 228 above and below the different configuration layers 216, 226 may remain the same for each configuration of the memory device 210, 220. As described above, in one embodiment, by maintaining identical layers 214, 218, 224, 228 and masks 202 used for depositing layers 214, 218, 224, 228 below and/or above the different configuration layers 216, 226, the costs for design, testing, and manufacturing of each of the configurations of the memory device 210, 220 may be reduced.

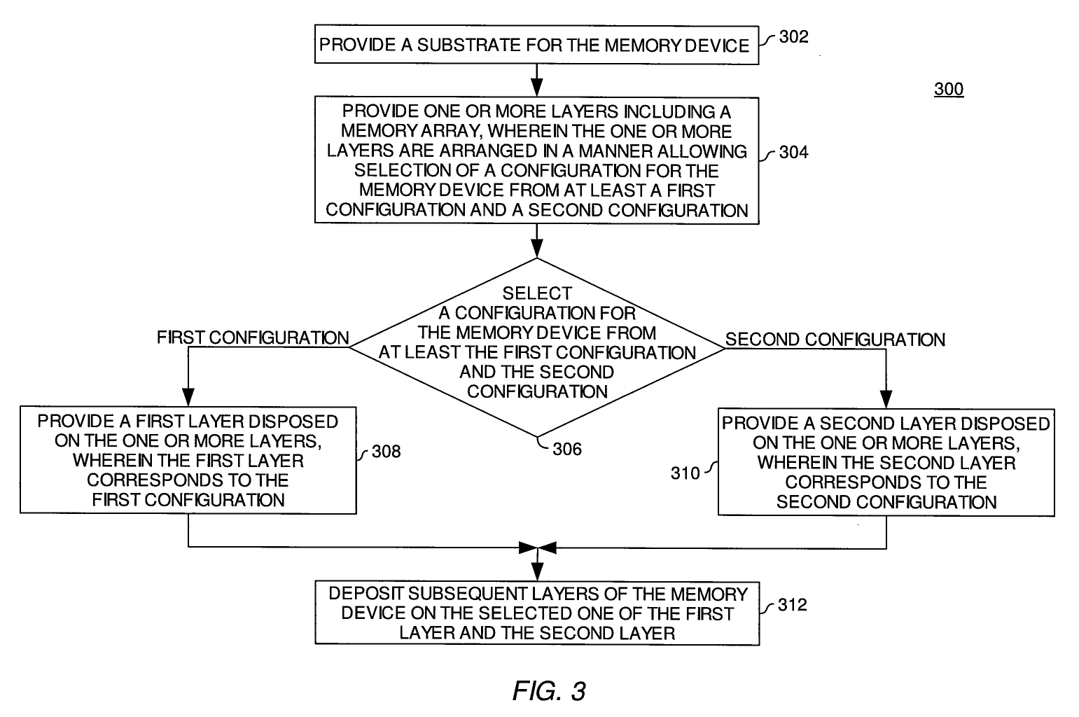

FIG. 3 is a block diagram depicting a method 300 for manufacturing a memory device with a selected configuration according to one embodiment of the invention. The method 300 may begin at step 302 where a substrate is provided for the memory device. At step 304, one or more layers including a memory array may be provided. The one or more layers may be arranged in a manner allowing selection of a configuration for the memory device from at least a first configuration and a second configuration.

At step 306, a configuration for the memory device may be selected from at least the first configuration and the second configuration. Where the first configuration is selected, a first layer disposed on the one or more layers and corresponding to the first configuration may be provided at step 308. As described above, the first layer may be deposited, for example, using a first set of one or more masks 204. In some cases, additional layers corresponding to the first configuration may also be deposited on the first layer. Similarly, where the second configuration is selected, a second layer disposed on the one or more layers and corresponding to the second configuration may be provided at step 318. Additional layers corresponding to the second configuration may also be deposited on the second layer. In some cases, the first and second configurations may also have differing numbers of layers.

In one embodiment, after the configuration has been selected and appropriate layers for the given configuration have been provided as described above, subsequent layers may be deposited on the previously deposited layers at step 312. As described above, in one embodiment, a single set of masks 202 may also be used for the subsequent layers (e.g., the subsequent layers may be identical), regardless of the selected configuration of the memory device. Thus, as described above, the cost of designing, testing, and manufacturing the memory device may be reduced. While described above with respect to a first configuration and a second configuration, embodiments of the invention may generally be used to provide any number of configurations.

### Providing Configurations for the Memory Device Via Separate Data Path Implementations

As described above, in one embodiment of the invention, each configuration of the memory device may differ in only a single layer and/or the interconnections to the single layer. In some cases, the single layer may only contain inactive elements such as metal interconnections and may not contain active elements such as transistors. For example, in one embodiment of the invention, each configuration of the memory device may differ with respect to the data path used for transmitting data (e.g., as opposed to commands or addresses) within the memory device. The data path may control data flow between read/write data lines (RWDL) and an external data bus (DQ) as described below. The different configurations implemented by the different data paths may correspond to SDR DRAM and DDR DRAM as described above.

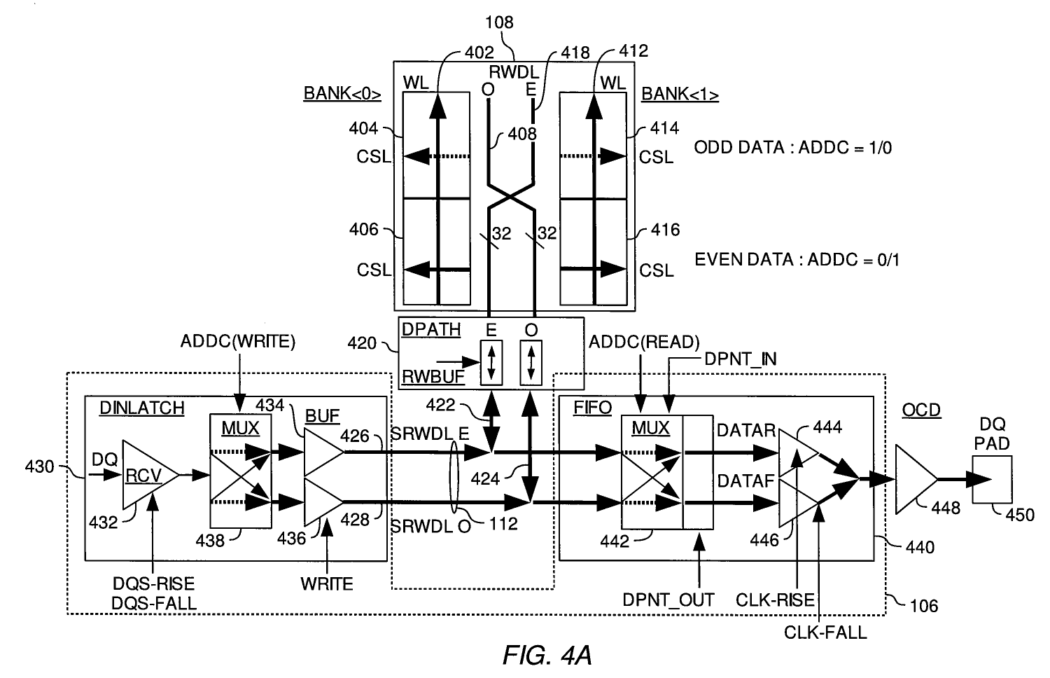

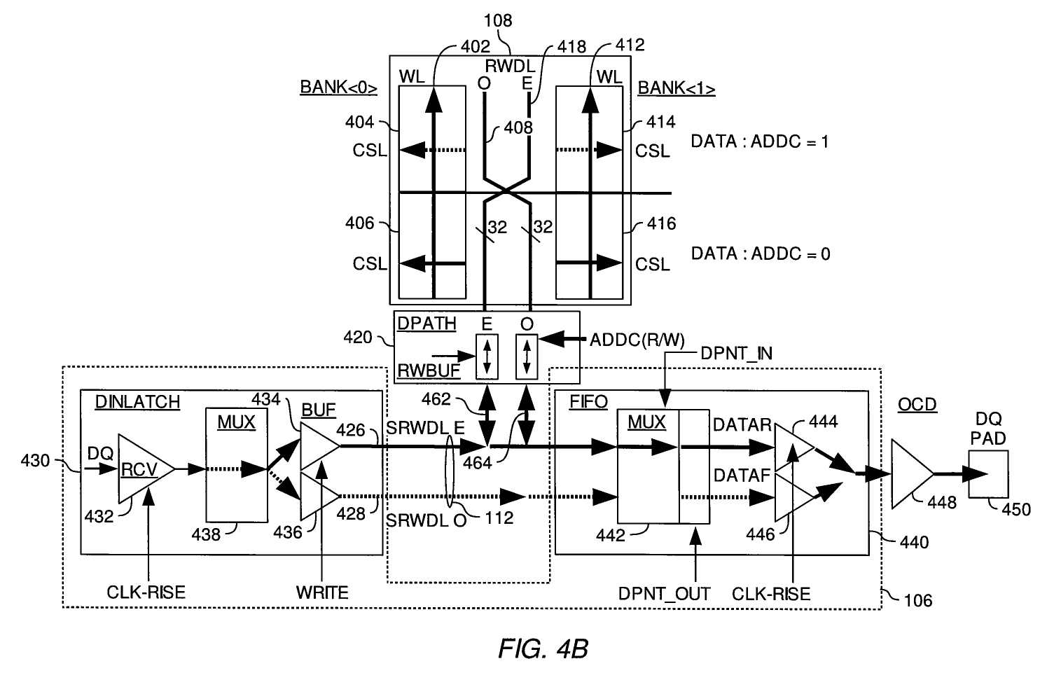

FIGS. 4A-B are block diagrams depicting separate configurations of the memory device according to one embodiment of the invention. FIG. 4A depicts an exemplary DDR configuration of a memory device 210 while FIG. 4B depicts an exemplary SDR configuration of a memory device 220. Operation of the memory devices 210, 220 and differences in the respective data paths are described below in greater detail.

As depicted in FIG. 4A, the memory array 108 may include two or more memory banks 402, 412 (here, BANK<0> and BANK<1>). During an access to the memory array 108, the memory bank to be accessed may be specified by a portion of the address provided to the memory device 100 referred to as the bank address bits. Each bank 402, 412 may be divided into multiple columns 404, 406, 414, 416. During an access, the address provided to the memory device 100 may be decoded to determine which column 404, 406, 414, 416 in a selected bank should be accessed.

When the column 404, 406, 414, 416 to be accessed has been identified as indicated by a column address bit ADDC<0>, the column may be selected for access by asserting a column select signal (CSL) for the appropriate column 404, 406, 414, 416. During a DDR access where data is read to or written from the memory device 100 on both the rising and falling edges of a clock signal, the column address bit ADDC<0> may be changed to select a column. For example, if an access starts with reading odd data (ADDC=1) on a rising edge of the clock signal, a subsequent access on the falling edge of the clock signal may read even data (ADDC=0).

In one embodiment, to improve the timing of each access, odd and even read/write data lines (RWDL) 408, 418 used by each bank 402, 412 may be twisted such that each of the banks 402, 412 shares the RWDL connections. Thus, during an access to a single bank (e.g., BANK<1>) 412, a first access on a rising edge of the clock signal may use a first RWDL 408 while a second access on a falling edge of the clock signal may use a second RWDL 418. Each data line (both RWDL 408, 418 and the SRWDL 426, 428 described below) may transmit multiple bits of data in parallel (e.g., each data line may transmit 32 bits in parallel). Timing may be improved, for example, because data for each of the separate accesses may use the separate RWDL connections without interference between each of the accesses.

Data from RWDL may be transmitted between RWDL and spine read/write data lines (SRWDL) 426, 428 via a buffer 420. For the DDR configuration, odd and even RWDL 408, 418 may be connected via the buffer 420 and connections 422, 424 to odd and even SRWDL 428, 426 respectively. SRWDL may be used to transmit data between read and write portions of the I/O circuitry 106 which may include an input latch (DINLATCH) 430 which receives data from an external data bus (DQ) via DQ pad 450 and an output first-in, first out (FIFO) circuit 440 which outputs data to the external data bus DQ via an off-chip driver (OCD) 448 connected to the DQ pad 450.

During a write access to the memory device 100 in the DDR configuration, write data may be received serially via the external data bus DQ on the DQ pad 450 and read in to the input latch 430 via receive circuitry 432 which receives the data on the rising and falling edge of the data clock signal DQS. The write data may be selected and provided to the even or odd SRWDL 426, 428 via a multiplexer (MUX) 438 controlled by the column address bit ADDC<0> and buffers 434, 436. In some cases, the control signals to the multiplexer 438 and buffers 434, 436 may only be activated or modified during a write access.

During a read access to the memory device 100 in the DDR configuration, data may be selected from the even or odd SRWDL 426, 428 using a MUX 442 controlled by the column address bit ADDC<0> and input into the FIFO 440 using a data-in signal DPNT_IN. Data for the rising and falling edge (DATAR and DATAF) may be output from the FIFO 440 using a data-out signal DPNT_OUT. The data for the rising and falling edge may output to the OCD 448 via output circuitry 444, 446 which is controlled by the rising and falling edge of the DQS clock signal, (CLK-RISE and CLK-FALL). The OCD 448 may drive the data being output onto the external data bus DQ via the DQ pad 450.

FIG. 4B is a block diagram of the memory device 100 in the SDR configuration where, as described above, data is output on a single edge of the clock signal. As described below, in one embodiment, the SDR configuration may contain the same active elements (e.g., memory arrays, transistors, etc.) as the DDR configuration and may be different with respect to the DDR configuration only with respect to connections and control connections of the data path. Furthermore, as described above, such connections may all be implemented in a single layer, for example, a metal layer such as M1. In some cases, by limiting changes between configurations to connections in a single layer, the cost of design, testing, and manufacturing of both the SDR and DDR configurations of the memory device 100 may be reduced.

With respect to FIG. 4B, the SDR configuration of the memory device may include the same RWDL 408, 418 and SRWDL 426, 428. RWDL 408, 418 and SRWDL 426, 428 may be implemented, in a layer which is above the layers of the data path which are modified between each of the configurations. For example, if changes to the data path are made in the M1 layer, RWDL 408, 418 and SRWDL 426, 428 may be implemented in the M2 layer. Also, as depicted in FIG. 4B, active elements in the SDR configuration such as the input latch 430, output FIFO 440, memory array 108, and RWDL/SRWDL buffer may be located in the same location as in the DDR configuration.

In one embodiment, changes to the data path may be implemented by changing connections between the data lines RWDL 408, 418 and SRWDL 426, 428, by changing connections between active elements (e.g., by connecting different active elements to each other or by routing the data path to bypass active elements entirely), and/or by changing control signals which are applied to a given active element (e.g., changes between each of the configurations may route different control signals to a given active element such as the multiplexer 438).

In one embodiment, in the SDR configuration (depicted in FIG. 4B), both the even and odd RWDL 408, 418 may be connected via connections 462, 464 to a single SRWDL (e.g., either SRWDL 426 as depicted or, optionally, SRWDL 428). As described above, in the DDR configuration, the even and odd RWDL 408, 418 may be connected to the separate even and odd SRWDL 426, 428. In the SDR configuration, connecting both the even and odd RWDL 408, 418 to a single SRWDL may be preferred, for example, because the access operation in the SDR configuration, wherein data is only input or output on a single clock edge, may not require data multiplexing (e.g., switching) between even and odd SRWDL 426, 428, allowing a single SRWDL to be used. As mentioned above, in one embodiment, the different connections (connections 422, 424 in the DDR configuration and connections 462, 464 in the SDR configuration) may be implemented in a single layer such as the M1 metal layer or any other layer.

In one embodiment, in the SDR configuration, control signals may be provided to active elements which are different from the control signals provided to the same elements in the DDR configuration. For example, as depicted in FIG. 4B (in comparison to FIG. 4A), the receive circuitry 432 may be connected to the rising edge of the clock signal CLK-RISE in the SDR configuration because during a write operation data may only be received on the rising edge of the clock signal. Similarly, a portion of the output circuitry 444 may only be connected the rising edge of the clock signal CLK-RISE because in the SDR configuration data may only be output using one of the SRWDL (in the depicted case, the even SRWDL 426) and only on the rising edge of the clock signal. Because a single SRWDL 426 may be used, the buffer circuit 420 may be controlled by the column address bit ADDC<0>to ensure that the appropriate one of the RWDL 408, 418 is connected to the single SRWDL 426 at a time. As mentioned above, in one embodiment, the change in control signals between the SDR and DDR configurations may be implemented in a single layer such as the M1 metal layer or any other layer.

In one embodiment, in the SDR configuration, active elements may be interconnected differently with respect to the connections which are provided to the same elements in the DDR configuration. For example, in addition to providing different control signals and other interconnections, the SDR configuration may provide connections which bypass certain active elements. In the SDR configuration, where a single SRWDL 426 is used, multiplexers 438, 442 for switching data between both SRDWL 426, 428 may not be needed. Thus, the multiplexers 438, 442 may be bypassed by a direct connection between the receive circuitry 432 and buffer circuitry 434 in the input latch 430 and by a direct connection between the SRWDL 426 and FIFO circuitry 440 bypassing the multiplexer 442. Optionally, in one embodiment of the invention, instead of using bypass connections, the control circuitry for each of the multiplexers 438, 442 may be connected to a selected value which provides an appropriate connection through the multiplexers 438, 442 to the SRWDL 426 being used. As mentioned above, the connections described above may be implemented in a single layer such as the M1 metal layer or any other layer.

In some cases, the connections described above may provide benefits which may be useful to a given configuration. For example, with respect to the SDR configuration, when data is being written to the device, the input latch 430 and appropriate portion of the buffer 420 between RWDL 408, 418 may be activated as soon as the write command and address are received without any additional decoding, thereby improving the timing performance of the write command.

Thus, as described above, the SDR configuration and DDR configuration of the memory device 100 may be provided with minimal changes between the configurations. Because changes between each of the configurations may be minimal, the cost of designing, testing, and manufacturing each of the device configurations may be reduced.

While the foregoing is directed to embodiments of the present invention, other and further embodiments of the invention may be devised without departing from the basic scope thereof, and the scope thereof is determined by the claims that follow.

What is claimed is:

1. A method for providing a memory device, the method comprising:
providing a substrate for the memory device;
providing one or more layers including a memory array of the memory device, wherein the one or more layers are arranged in a manner allowing selection of a configuration for the memory device from at least a first configuration and a second configuration, wherein operation of the memory device is different in the first configuration with respect to the second configuration;
selecting a configuration for the memory device from at least the first configuration and the second configuration;
providing a first layer disposed on the one or more layers if the first configuration is selected, wherein the first layer corresponds to the first configuration; and
providing a second layer disposed on the one or more layers if the second configuration is selected, wherein the second layer corresponds to the second configuration.

2. The method of claim 1, wherein a memory device with the first configuration differs from a memory device with the second configuration in a single layer and the connections to the single layer, wherein the single layer corresponds to one of the first layer and the second layer.

3. The method of claim 2, wherein the single layer is a layer of metal interconnections.

4. The method of claim 1, further comprising:
providing a first mask corresponding to the first layer;
providing a second mask corresponding to the second layer;
forming the first layer from the first mask if the first configuration is selected; and
forming the second layer from the second mask if the second configuration is selected.

5. The method of claim 1, wherein the first configuration provides a first data path different from a second data path for the second configuration.

6. The method of claim 1, wherein the first configuration corresponds to a single data rate memory device and wherein the second configuration corresponds to a double data rate memory device.

7. A memory device comprising:
a substrate;
a memory array;
one or more base layers including the memory array, wherein the one or more layers are arranged in a manner allowing selection of a configuration for the memory device from at least a first configuration and a second configuration, wherein operation of the memory device is different in the first configuration with respect to the second configuration; and
one or more layers comprising at least one of:
a first layer disposed on the one or more base layers where the first configuration is selected, wherein the first layer corresponds to the first configuration; and
a second layer disposed on the one or more base layers where the second configuration is selected, wherein the second layer corresponds to the second configuration.

8. The memory device of claim 1, wherein a memory device with the first configuration differs from a memory device with the second configuration in a single layer and the connections to the single layer, wherein the single layer corresponds to one of the first layer and the second layer.

9. The memory device of claim 2, wherein the single layer is a layer of metal interconnections.

10. The memory device of claim 1, wherein, in the first configuration, the memory device provides a first data path different from a second data path for the second configuration.

11. The memory device of claim 1, wherein, in the first configuration, the memory device is configured to provide single data rate access timing and wherein, in the second configuration, the memory device is configured to provide double data rate access timing.

12. A method for manufacturing a memory device, the method comprising:
depositing one or more layers including a memory array of the memory device on a substrate, wherein the one or more layers are arranged in a manner allowing selection of a configuration for the memory device from at least a single data rate configuration and a double data rate configuration;
selecting a configuration for the memory device from at least the single data rate configuration and the double data rate configuration;
depositing a first layer on the one or more layers if the first configuration is selected, wherein the first layer corresponds to the single data rate configuration; and
depositing a second layer disposed on the one or more layers if the second configuration is selected, wherein the second layer corresponds to the double data rate configuration.

13. The method of claim 12, wherein a memory device with the single data rate configuration differs from a memory device with the double data rate configuration in a single layer and the connections to the single layer, wherein the single layer corresponds to one of the first layer and the second layer.

14. The method of claim 13, wherein the single layer is a layer of metal interconnections.

15. The method of claim 14, wherein the layer of metal interconnections is a metal one (M1) layer.

16. The method of claim 12, further comprising:
providing a first mask corresponding to the first layer;
providing a second mask corresponding to the second layer;
forming the first layer from the first mask if the single data rate configuration is selected; and
forming the second layer from the second mask if the double data rate configuration is selected.

17. The method of claim 12, wherein the single data rate configuration provides a first data path different from a second data path for the double data rate configuration.

18. A method for providing a memory device, the method comprising:
providing one or more base layers including a memory array of the memory device, wherein the one or more layers are arranged in a manner allowing selection of a configuration for the memory device from at least a first configuration and a second configuration, wherein operation of the memory device is different in the first configuration with respect to the second configuration;
selecting a configuration for the memory device from at least the first configuration and the second configuration;
providing one or more first layers disposed on the one or more base layers if the first configuration is selected, wherein the one or more first layers correspond to the first configuration, and wherein the one or more first layers provide a first data path; and
providing one or more second layers disposed on the one or more base layers if the second configuration is selected, wherein the one or more second layers correspond to the second configuration, and wherein the one or more second layers provide a second data path different from the first data path.

19. The method of claim 18, further comprising:
providing at least two read/write data lines connected to the memory array; and
providing at least two spine read/write data lines configured to transmit data between the two read/write data lines connected to the memory array and the input/output circuitry;
wherein providing the one or more second layers comprises connecting a first and second of the at least two read/write data lines to a first and second of the at least two spine read/write data lines respectively if the second configuration is selected; and
wherein providing the one or more first layers comprises connecting the first and second of the at least two read/write data lines to the first of the at least two spine read/write data lines if the first configuration is selected.

20. The method of claim 19:
wherein providing the one or more base layers comprises providing a multiplexer to select one of the at least two spine read/write data lines to be connected to the input/output circuitry if the second configuration is selected; and
wherein providing the one or more first layers comprises providing a bypass path to bypass the multiplexer and connect a single one of the at least two spine read/write data lines if the first configuration is selected.

21. The method of claim 18:
wherein providing the one or more first layers comprises providing first control connections to the first data path to implement a single data rate configuration if the first configuration is selected; and
wherein providing the one or more second layers comprises providing second control connections to the second data path to implement a double data rate configuration if the second configuration is selected.

22. The method of claim 18, wherein portions of the first data path and second data path which are different are contained in a single layer of metal.

23. A memory device comprising:
a memory array;
one or more base layers including the memory array, wherein the one or more layers are arranged in a manner allowing selection of a configuration for the memory device from at least a first configuration and a second configuration, wherein operation of the memory device is different in the first configuration with respect to the second configuration;
one or more layers comprising at least one of:
one or more first layers disposed on the one or more base layers and configured to provide a first configuration of the memory device, wherein the one or more first layers provide a first data path; and
one or more second layers disposed on the one or more base layers and configured to provide a second configuration of the memory device, wherein the one or more second layers provide a second data path different from the first data path.

24. The memory device of claim 23, further comprising:
at least two read/write data lines connected to the memory array; and
at least two spine read/write data lines configured to transmit data between the two read/write data lines connected to the memory array and the input/output circuitry; and
wherein the one or more layers comprise a connection comprising at least one of:
a connection between a first and second of the at least two read/write data lines and a first and second of the at least two spine read/write data lines respectively where the memory device provides the second configuration; and
a connection between the first and second of the at least two read/write data lines and the first of the at least two spine read/write data lines where the memory device provides the first configuration.

25. The memory device of claim 24:
wherein the one or more base layers further comprise a multiplexer, wherein the multiplexer is configured to select one of the at least two spine read/write data lines to be connected to the input/output circuitry where the memory device provides the second configuration; and
wherein the one or more layers a bypass path configured to bypass the multiplexer and connect a single one of the at least two spine read/write data lines where the memory device provides the first configuration.

26. The memory device of claim 23, wherein the one or more layers further comprise control connections comprising at least one of:
first control connections to the first data path to implement a single data rate configuration where the memory device provides the first configuration; and
second control connections to the second data path to implement a double data rate configuration where the memory device provides the second configuration.

27. The memory device of claim 23, wherein portions of the first data path and second data path which are different are contained in a single layer of metal.

28. A single data rate memory device comprising:
a substrate;
a memory array;
input/output circuitry configured to input data into the memory device and output data from the memory device;
at least two read/write data lines connected to the memory array; and
at least two spine read/write data lines configured to transmit data between the two read/write data lines connected to the memory array and the input/output circuitry, wherein only one of the at least two spine read/write data lines are connected to the at least two read/write data lines.

29. The memory device of claim 28, further comprising:
one or more base layers including the memory array, wherein the one or more layers are arranged in a manner allowing selection of a configuration for the memory device from at least a single data rate configuration and a double data rate configuration, wherein the memory device is configured in the single data rate configuration.

30. The memory device of claim 28, wherein the at least two read/write data lines comprise a first data line and a second data line, wherein the memory array comprises a first bank and a second bank, and wherein the first data line and the second data line are each shared between the first bank and the second bank.
